(19) United States
(12) Patent Application Publication
(10) Pub. No.: US 2020/0364642 A1
(43) Pub. Date: Nov. 19, 2020

(54) MANAGEMENT DEVICE, MANAGEMENT METHOD, AND MANAGEMENT PROGRAM

(71) Applicant: TOYOTA JIDOSHA KABUSHIKI KAISHA, Toyota-shi (JP)

(72) Inventors: Naoko YOSHIZAWA, Nagoya-shi (JP); Takumi FUKUNAGA, Nagoya-shi (JP); Shinichirou FUJII, Kawasaki-shi (JP); Hiromitsu FUJII, Kariya-shi (JP)

(73) Assignee: TOYOTA JIDOSHA KABUSHIKI KAISHA, Toyota-shi (JP)

(21) Appl. No.: 16/858,843

(22) Filed: Apr. 27, 2020

(30) Foreign Application Priority Data
May 15, 2019 (JP) 2019-092039

(51) Int. Cl. G06Q 10/06; G06Q 50/30; G06Q 10/10; G06Q 10/08; G06Q 30/06; G06F 16/9537

(52) U.S. Cl. CPC G06Q 10/06315; G06Q 50/30; G06Q 10/10; G06F 16/9537; G06Q 10/0838; G06Q 30/0645; G06Q 10/0836

(57) ABSTRACT

A management device includes a memory and a processor including hardware. The processor is configured to extract a combination of luggage and a vehicle in which a delivery destination included in delivery request information for requesting delivery of luggage and a destination included in use request information satisfy matching conditions based on the delivery request information and the use request information for requesting use of a vehicle which is able to be used through a request by a plurality of users and which is able to provide a vehicular compartment for loading luggage of which delivery is requested by a requester other than the users.

### INCORPORATION BY REFERENCE

The disclosure of Japanese Patent Application No. 2019-092039 filed on May 15, 2019 including the specification, drawings and abstract is incorporated herein by reference in its entirety.

### BACKGROUND

### 1. Technical Field

The disclosure relates to a management device, a management method, and a management program.

### 2. Description of Related Art

A technique of using a trunk of a general automobile which is registered as a vehicle for loading luggage as a delivery place of a delivery object when a home delivery service provider picks up and delivers luggage is known (for example, see Japanese Patent Application Publication No. 2006-206225 (JP 2006-206225 A)). In this technique, at the time of performing pickup and delivery of luggage, an authentication process is performed between a pickup and delivery communication device of a pickup and delivery service provider and a vehicular communication device mounted in a designated vehicle, and a trunk of the designated vehicle can be locked or unlocked when the authentication is successful.

A technique of distributing luggage to transportation vehicles or passengers and delivering the luggage depending on passenger transportation vehicles such as taxis or buses and operating conditions of the passengers is known (for example, see Japanese Patent Application Publication No. 2004-59213 (JP 2004-59213 A)).

### SUMMARY

Recently, a carsharing system in which a plurality of users shares and uses a single vehicle has spread. In this system, convenience for a user is generally sought, and it is not supposed that a carsharing vehicle has the function of a vehicle for loading luggage.

The disclosure provides a management device, a management method, and a management program that can achieve two individual purposes including rental of a vehicle and delivery of luggage using a single vehicle.

According to the disclosure, there is provided a management device including: a memory; and a processor including hardware. The processor is configured to extract a combination of luggage and a vehicle in which a delivery destination included in delivery request information for requesting delivery of luggage and a destination included in use request information satisfy matching conditions based on the delivery request information and the use request information for requesting use of a vehicle which is able to be used through a request by a plurality of users and which is able to provide a vehicular compartment for loading luggage of which delivery is requested by a requester other than the users.

The matching conditions may include a condition that a distance between the delivery destination and the destination is equal to or less than a predetermined distance and a condition that the luggage is scheduled to be received in a parking/stopping period at the destination of the vehicle.

According to this configuration, it is possible to extract a combination of luggage and a vehicle in which a distance between a delivery destination and a destination is small and a requester can reliably receive luggage.

The matching conditions may further include a condition which is determined based on use history information of a user of the vehicle.

According to this configuration, it is possible to extract a more appropriate combination of luggage and a vehicle in additional consideration of conditions based on past use histories of users.

The processor may be configured to generate matching information including at least a part of the delivery request information and the use request information corresponding to the extracted combination, and to transmit the matching information to a requester terminal which is a transmission source of the delivery request information corresponding to the combination, a user terminal which is a transmission source of the use request information corresponding to the combination, and a pickup and delivery person terminal corresponding to a pickup and delivery person of the luggage which is a part of the combination.

According to this configuration, since the matching information is transmitted to a requester terminal, a user terminal, and a pickup and delivery person terminal, all persons who are associated with delivery of luggage and use of a vehicle can share information and thus it is possible to satisfactorily achieve two individual purposes including rental of a vehicle and delivery of luggage.

According to the disclosure, there is provided a management method which is performed by a management device including a memory and a processor including hardware, the management method including: reading delivery request information for requesting delivery of luggage and use request information for requesting use of a vehicle which is able to be used through a request by a plurality of users and which is able to provide a vehicular compartment for loading luggage of which delivery is requested by a requester other than the users from the memory; and extracting a combination of luggage and a vehicle in which a delivery destination included in the delivery request information and a destination included in the use request information satisfy matching conditions.

According to the disclosure, there is provided a management program causing a management device including a memory and a processor including hardware to perform: extracting a combination of luggage and a vehicle in which a delivery destination included in delivery request information for requesting delivery of luggage and a destination included in use request information satisfy matching conditions based on the delivery request information and the use request information for requesting use of a vehicle which is able to be used through a request by a plurality of users and which is able to provide a vehicular compartment for loading luggage of which delivery is requested by a requester other than the users.

According to the disclosure, since a combination of luggage and a vehicle in which a delivery destination included in delivery request information and a destination included in use request information satisfy matching conditions is extracted, it is possible to extract an appropriate combination of luggage and a vehicle and to achieve two individual purposes including rental of a vehicle and delivery of luggage using a single vehicle.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram schematically illustrating a pickup and delivery system including a management device according to an embodiment;

FIG. 2 is a block diagram illustrating a functional configuration of the pickup and delivery system including the management device according to the embodiment;

FIG. 3 is a diagram schematically illustrating delivery request information which is stored in the management device according to the embodiment;

FIG. 4 is a diagram schematically illustrating use request information which is stored in the management device according to the embodiment;

FIG. 5 is a diagram schematically illustrating matching information which is stored in the management device according to the embodiment;

FIG. 6 is a sequence diagram illustrating the outline (a first part) of a process flow which is performed by the pickup and delivery system including the management device according to the embodiment;

FIG. 7 is a sequence diagram illustrating the outline (a second part) of the process flow which is performed by the pickup and delivery system including the management device according to the embodiment; and

FIG. 8 is a sequence diagram illustrating the outline (a third part) of the process flow which is performed by the pickup and delivery system including the management device according to the embodiment.

### DETAILED DESCRIPTION OF EMBODIMENTS

Hereinafter, a mode for carrying out the disclosure (hereinafter referred to as an “embodiment”) will be described with reference to the accompanying drawings.

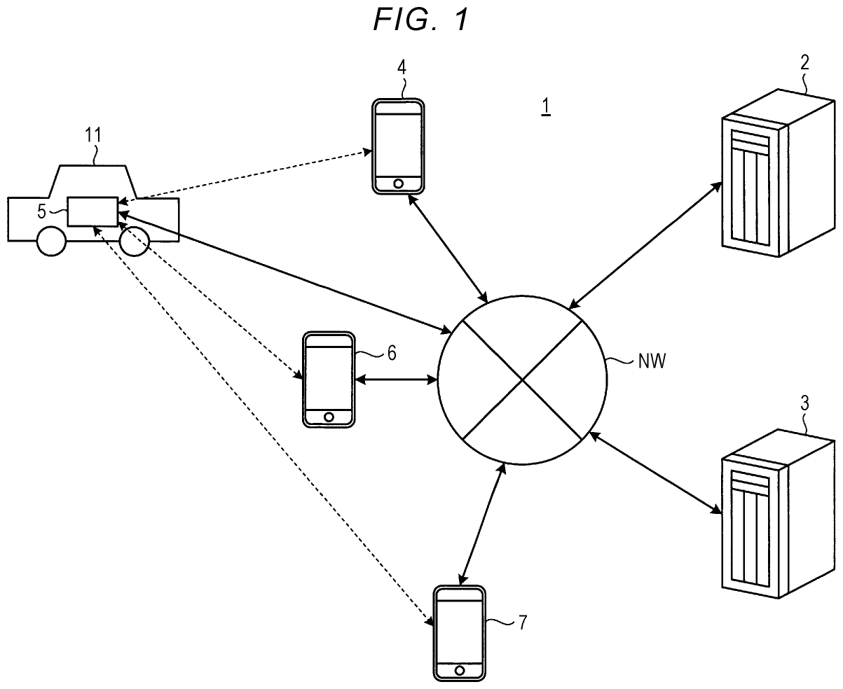

FIG. 1 is a diagram schematically illustrating a pickup and delivery system including a management device according to an embodiment. A pickup and delivery system 1 is a system that performs pickup and delivery of luggage using a vehicle 11 which can be used through a request by a plurality of users and which can provide a vehicular compartment for loading luggage of which delivery has been requested by a requester other than the users. In other words, a vehicle 11 constituting the pickup and delivery system 1 is a vehicle that can perform both car sharing and trunk sharing. A vehicular compartment of a vehicle 11 includes a trunk and a passenger space of the vehicle 11.

The pickup and delivery system 1 includes a management device 2 that manages delivery of luggage, a central server 3 that manages opening and closing of a vehicular compartment of a vehicle 11, a pickup and delivery person terminal 4 that corresponds to a pickup and delivery person, an onboard device 5 that is mounted in a vehicle 11, a requester terminal 6 that corresponds to a requester for delivery of luggage, and a user terminal 7 corresponds a user who rents and uses a vehicle 11. The management device 2, the central server 3, the pickup and delivery person terminal 4, the onboard device 5, the requester terminal 6, and the user terminal 7 are communicatively connected to a communication network NW. The pickup and delivery person terminal 4, the requester terminal 6, and the user terminal 7 are communicatively connected to the onboard device 5 by short-range radio communication. The communication network NW is constituted by, for example, one of a local area network (LAN), a wide area network (WAN), a public communication line, a virtual private network (VPN), and a dedicated communication line or a combination of two or more thereof. The communication network NW is constituted by a combination of a network based on wired communication and a network based on wireless communication. Examples of the short-range radio communication standard include Bluetooth (registered trademark) Low Energy (BLE), near field communication (NFC), ultra wideband (UWB), and WiFi (registered trademark).

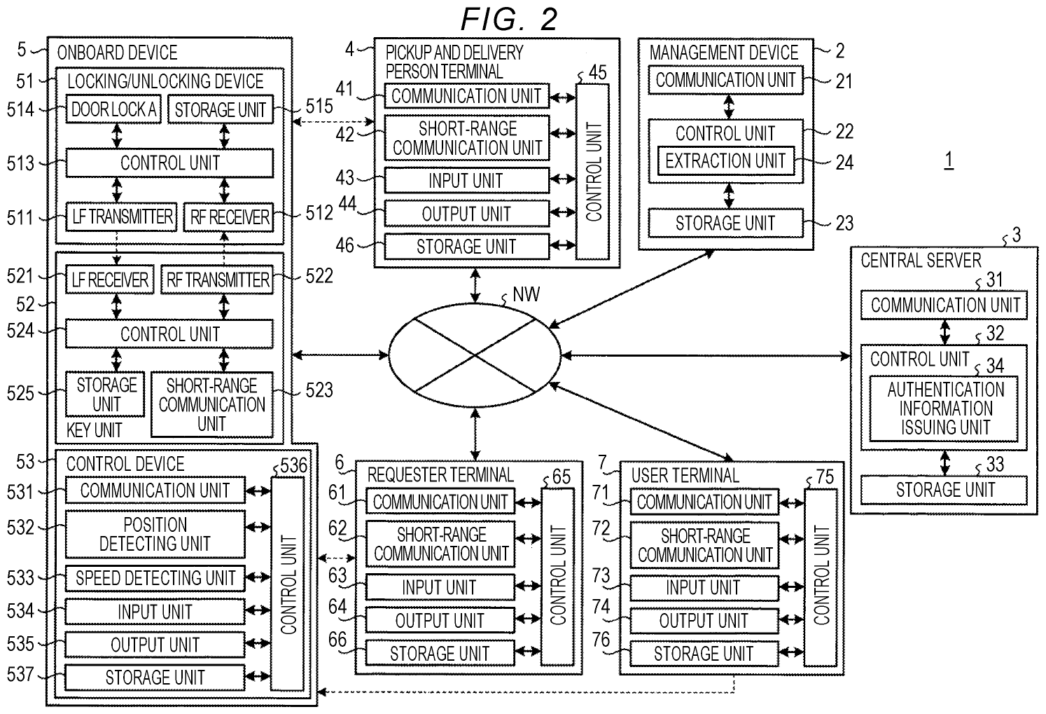

FIG. 2 is a block diagram illustrating a functional configuration of the pickup and delivery system 1. The functional configuration of each element of the pickup and delivery system 1 will be described below.

Management Device 2

The management device 2 includes a communication unit 21, a control unit 22, and a storage unit 23.

The communication unit 21 is an interface that communicates with the central server 3, the pickup and delivery person terminal 4, the requester terminal 6, and the user terminal 7 via the communication network NW.

The control unit 22 comprehensively controls the whole pickup and delivery system 1 by managing pickup and delivery of luggage and managing rental of vehicles 11. The control unit 22 includes an extraction unit 24 that, based on delivery request information of luggage which is received from the requester terminal 6 and use request information of a vehicle 11 which is received from the user terminal 7, compares information of a delivery destination of luggage included in the delivery request information with information of a destination of a vehicle 11 included in the use request information and extracts a combination of luggage and a vehicle 11 in which the delivery destination and the destination satisfy predetermined matching conditions. The matching conditions include, for example, a condition that a distance between the delivery destination and the destination is equal to or less than a predetermined distance and a condition that the luggage is scheduled to be received in a parking/stopping period in the destination of the vehicle. The extraction unit 24 generates matching information on the extracted combination of luggage and a vehicle 11 and stores the matching information in the storage unit 23. Details of the matching information will be described later.

The control unit 22 is a processor which is constituted by hardware such as a general-purpose processor such as a central processing unit (CPU) or a dedicated integrated circuit performing a specific function such as a field programmable gate array (FPGA) alone or in combination. The control unit 22 performs various operation processes for causing the management device 2 to operate by reading various programs stored in the storage unit 23.

The storage unit 23 stores the delivery request information transmitted from the requester terminal 6, the use request information transmitted from the user terminal 7, and the matching information on the combination of luggage and a vehicle 11 extracted by the extraction unit 24. Instead of being stored in the storage unit 23, this information may be stored in a device which is different from the management device 2.

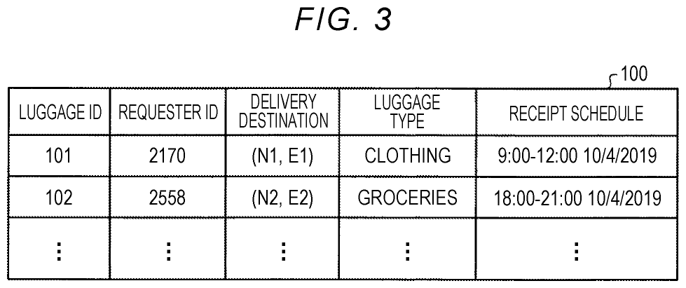

FIG. 3 is a diagram schematically illustrating delivery request information which is stored in the storage unit 23. In a table 100 illustrated in the drawing, a luggage ID, a requester ID, latitude and longitude information of a point which is set as a delivery destination, a luggage type, and a scheduled receipt are described for each piece of luggage. For example, luggage with a luggage ID 101 is luggage for which a delivery request is received from a requester with a requester ID 2170, and a delivery destination thereof is a point with N1 of north latitude and E1 of east longitude. Specific values of the north latitude and the east longitude are described in N1 and E1. The luggage type is clothing, and the scheduled receipt of luggage by a requester is a time period from 9:00 to 12:00 on Apr. 10, 2019.

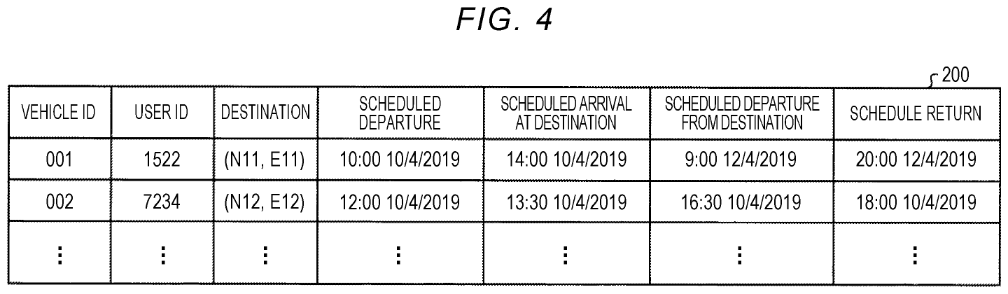

FIG. 4 is a diagram schematically illustrating use request information which is stored in the storage unit 23. In a table 200 illustrated in the drawing, a vehicle ID, a user ID, latitude and longitude information of a point which is set as a destination, a scheduled departure, a scheduled arrival at a destination, a scheduled departure from a destination, and a scheduled return are described for each vehicle 11 which is to be rented. For example, a vehicle 11 with a vehicle ID of 001 is requested by a user with a user ID of 1522. A destination of the vehicle 11 is a point with N11 of north latitude and E11 of east longitude. Specific values of the north latitude and the east longitude are described in N11 and E11. The scheduled departure of the vehicle 11 is 10:00 on Apr. 10, 2019, the scheduled arrival at the destination is 14:00 on Apr. 10, 2019, the scheduled departure from the destination is 9:00 on Apr. 12, 2019, and the scheduled return is 20:00 on Apr. 12, 2019. Accordingly, a parking/stopping period at the destination of the vehicle 11 is scheduled to be from 14:00 on Apr. 10, 2019, to 9:00 on Apr. 12, 2019.

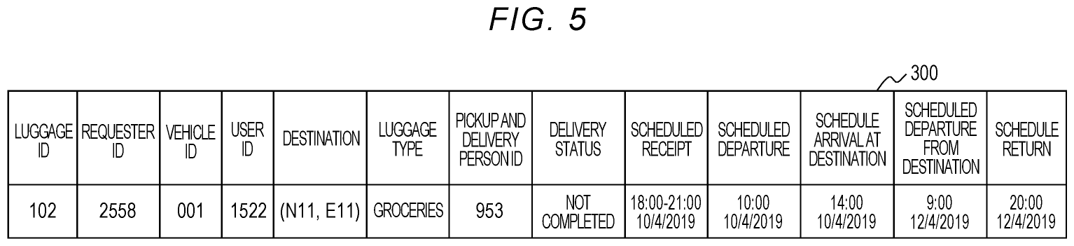

FIG. 5 is a diagram schematically illustrating matching information which is stored in the storage unit 23. In a table 300 illustrated in the drawing, information on a combination of luggage and a vehicle which is extracted based on the matching conditions by the extraction unit 24 is described. In the table 300, a pickup and delivery person ID and a delivery status of luggage are described in addition to information on a combination of luggage with a luggage ID of 102 in the table 100 and a vehicle 11 with a vehicle ID of 001 in the table 200. In the table 300, information of the destination of the vehicle 11 is described but information of the delivery destination of luggage is not described. This means that higher priority is given to the destination of the vehicle 11 than to the delivery destination of luggage and the delivery destination of luggage is changed to the destination of the vehicle 11. On the other hand, higher priority may be given to the delivery destination of luggage than to the destination of the vehicle 11 and the destination of the vehicle 11 may be changed to the delivery destination of luggage, or a predetermined point (for example, a midpoint) between the delivery destination of luggage and the destination of the vehicle 11 may be set as a new delivery destination and a new destination.

The storage unit 23 additionally stores various programs for performing the operation of the management device 2. The programs include a management program causing the management device 2 to extract a combination of a delivery destination of luggage and a destination of a vehicle satisfying the matching conditions.

The storage unit 23 is constituted by a volatile memory such as a random access memory (RAM) and a nonvolatile memory such as a read only memory (ROM). The storage unit 23 may be constituted by a computer-readable recording medium such as a memory card which can be attached from the outside. Various programs which are stored in the storage unit 23 may be recorded on a computer-readable recording medium such as a hard disk, a flash memory, a CD-ROM, a DVD-ROM, or a flexible disk and may be widely distributed.

Central Server 3

The central server 3 is an authentication management device that manages authentication information of a plurality of vehicles 11. The central server 3 includes a communication unit 31, a control unit 32, and a storage unit 33.

The communication unit 31 is an interface that communicates with the management device 2 via the communication network NW.

The control unit 32 includes an authentication information issuing unit 34. The authentication information issuing unit 34 issues authentication information for locking or unlocking a vehicle 11. When a request for issuing authentication information for locking or unlocking the vehicle 11 is received from the pickup and delivery person terminal 4, the requester terminal 6, or the user terminal 7 via the management device 2, the authentication information issuing unit 34 transmits authentication information corresponding to a key unit 52 to the pickup and delivery person terminal 4, the requester terminal 6, or the user terminal 7 via the management device 2. The authentication information issuing unit 34 may generate authentication information including information of a validity period.

The control unit 32 is, for example, a processor which is constituted by hardware such as a CPU or an FPGA alone or in combination. The control unit 32 performs various operation processes for causing the central server 3 to operate by reading various programs stored in the storage unit 33.

The storage unit 33 stores information which is required for the authentication information issuing unit 34 to issue authentication information or various programs for performing the operation of the central server 3. The storage unit 33 is constituted by a RAM, a ROM, and the like.

Pickup and Delivery Person Terminal 4

The pickup and delivery person terminal 4 includes a communication unit 41, a short-range communication unit 42, an input unit 43, an output unit 44, a control unit 45, and a storage unit 46. The pickup and delivery person terminal 4 is a terminal that corresponds to a pickup and delivery person of luggage and is a terminal that is carried by the pickup and delivery person. The pickup and delivery person terminal 4 is constituted, for example, by a smartphone, a mobile phone, a tablet terminal, a personal information terminal, or a wearable computer.

The communication unit 41 is an interface that communicates with the management device 2 via the communication network NW.

The short-range communication unit 42 is an interface that performs short-range radio communication with the onboard device 5. The short-range communication unit 42 performs short-range radio communication based on any standard of BLE, NFC, UWB, and WiFi (registered trademark).

The input unit 43 is constituted by a user interface such as a keyboard, buttons, a lever, a touch panel that is provided to overlap a display of the output unit 44, and a microphone for inputting speech and receives an input of various information.

The output unit 44 is constituted by a display using liquid crystal or organic electroluminescence (EL), a speaker for outputting speech, and the like.

The control unit 45 controls the operation of the pickup and delivery person terminal 4. The control unit 45 is, for example, a processor which is constituted by hardware such as a CPU or an FPGA alone or in combination. The control unit 45 performs various operation processes for causing the pickup and delivery person terminal 4 to operate by reading various programs stored in the storage unit 46.

The storage unit 46 stores various programs for performing the operation of the pickup and delivery person terminal 4. The storage unit 46 is constituted by a RAM, a ROM, and the like.

The pickup and delivery person terminal 4 may further include an imaging unit which is constituted by an image sensor such as a CCD or a CMOS. In this case, a pickup and delivery person images a state of a vehicular compartment using the pickup and delivery person terminal 4 and transmits data of a captured image to the management device 2. The management device 2 ascertains availability of the vehicular compartment by image recognition based on the received data of an image.

An application for displaying parking/stopping information of a vehicle 11 may be provided as an application which can be downloaded by the pickup and delivery person terminal 4.

Onboard Device 5

The onboard device 5 is mounted in a vehicle 11. The onboard device 5 includes a locking/unlocking device 51, a key unit 52, and a control device 53. The onboard device 5 performs a series of processes for locking or unlocking a vehicular compartment of the vehicle 11 by causing the locking/unlocking device 51 to operate through an authentication process by the key unit 52 based on authentication information which is transmitted from the pickup and delivery person terminal 4, the requester terminal 6, or the user terminal 7. In the onboard device 5, the control device 53 detects a position or a moving state of the vehicle 11 and transmits the detected information to the management device 2 via the communication network NW. A validity period is set in the authentication information which is transmitted by the pickup and delivery person terminal 4, the requester terminal 6, and the user terminal 7.

The locking/unlocking device 51 is a device that locks or unlocks doors of the vehicular compartment of the vehicle 11. The locking/unlocking device 51 includes an LF transmitter 511, an RF receiver 512, a control unit 513, a door lock actuator 514, and a storage unit 515. In FIG. 2, the door lock actuator is illustrated as “door lock A.”

The LF transmitter 511 transmits radio waves of a low frequency band (for example, 100 KHz to 300 KHz) for detecting (polling) the key unit 52. For example, the LF transmitter 511 is incorporated in the vicinity of a center console or a steering wheel in the vehicular compartment.

The RF receiver 512 receives radio waves of a high frequency band (for example, 100 MHz to 1 GHz) which is transmitted from the key unit 52. The RF receiver 512 is incorporated at a position in the vehicular compartment.

The control unit 513 compares a key ID included in a locking/unlocking signal which is received from the key unit 52 with a key ID stored in the storage unit 515. When it is determined that the received key ID is valid, the control unit 513 transmits a signal for locking or unlocking doors of the vehicular compartment for loading luggage of the vehicle 11 to the door lock actuator 514.

The control unit 513 is constituted, for example, by hardware such as a CPU or an FPGA alone or in combination. The control unit 513 may be constituted by a plurality of electronic control units (ECUs) which are communicatively connected to each other via an onboard network such as a controller area network (CAN). In the following description, a locking signal and an unlocking signal may be collectively referred to as a locking/unlocking signal.

The door lock actuator 514 is an actuator that locks or unlocks doors of the vehicular compartment of the vehicle 11. The door lock actuator 514 operates based on the locking/unlocking signal which is transmitted from the control unit 513. The door lock actuator 514 may independently lock or unlock the doors of the vehicle 11. For example, when a trunk is used as a vehicular compartment for loading luggage, the door lock actuator 514 may lock or unlock only the trunk.

The storage unit 515 stores various types of information including a key ID of doors of the vehicular compartment or various programs for causing the locking/unlocking device 51 to operate. The storage unit 515 is constituted by a RAM, a ROM, and the like.

The key unit 52 includes an LF receiver 521, an RF transmitter 522, a short-range communication unit 523, a control unit 524, and a storage unit 525. The key unit 52 is disposed at a predetermined position such as a glove box in the vehicular compartment of the vehicle 11.

The LF receiver 521 receives a polling signal which is transmitted from the locking/unlocking device 51 using radio waves of a low frequency band. The LF receiver 521 includes an antenna for receiving radio waves of a low frequency band (hereinafter referred to as an LF antenna).

The RF transmitter 522 transmits a locking/unlocking signal to the locking/unlocking device 51 using radio waves of a high frequency band.

The short-range communication unit 523 is a communication interface that performs short-range radio communication with the pickup and delivery person terminal 4, the requester terminal 6, or the user terminal 7.

The control unit 524 controls the operation of the key unit 52. The control unit 524 compares authentication information which is included in a locking request or unlocking request received from the pickup and delivery person terminal 4, the requester terminal 6, or the user terminal 7 with authentication information which is stored in the storage unit 525, and determines that authentication is successful when this authentication information has a predetermined relationship. The predetermined relationship which is mentioned herein includes one of a relationship in which the authentication information stored in the storage unit 525 and the authentication information received from the pickup and delivery person terminal 4, the requester terminal 6, or the user terminal 7 are the same, a relationship in which results of a predetermined process such as encryption or decryption using the two pieces of authentication information are the same, and a relationship in which a result of a decryption process performed on one of the two pieces of authentication information is the same as a result of the decryption process performed on the other.

When the control unit 524 has successfully authenticated the pickup and delivery person terminal 4, the requester terminal 6, or the user terminal 7, the control unit 524 transmits a locking/unlocking signal which is generated in response to a request received from the pickup and delivery person terminal 4, the requester terminal 6, or the user terminal 7 via the RF transmitter 522 to the locking/unlocking device 51.

The control unit 524 is constituted, for example, by hardware such as a CPU or an FPGA alone or in combination.

The storage unit 525 stores authentication information for authenticating the pickup and delivery person terminal 4, the requester terminal 6, or the user terminal 7 and also stores a key ID. The storage unit 525 may encrypt and store a key ID. When the storage unit 525 encrypts and stores a key ID, the control unit 524 receives decryption information from the pickup and delivery person terminal 4, the requester terminal 6, or the user terminal 7 and decrypts the key ID based on the received decryption information.

The storage unit 525 stores various programs for performing the operation of the key unit 52. The storage unit 525 is constituted by a RAM, a ROM, and the like. In the following description, the authentication information stored in the storage unit 525 may be referred to as device authentication information and the authentication information transmitted from the pickup and delivery person terminal 4, the requester terminal 6, or the user terminal 7 may be referred to as terminal authentication information.

The key unit 52 having the above-mentioned configuration can enable locking and unlocking of the vehicular compartment of the vehicle 11 without using a physical key by communicating with the locking/unlocking device 51 of the onboard device 5.

The control device 53 includes a communication unit 531, a position detecting unit 532, a speed detecting unit 533, an input unit 534, an output unit 535, a control unit 536, and a storage unit 537.

The communication unit 531 is an interface that performs communication with the management device 2 via the communication network NW. The communication unit 531 transmits position information and speed information of the vehicle 11 to the management device 2.

The position detecting unit 532 is constituted, for example, by a GPS sensor that receives GPS signals transmitted from Global Positioning System (GPS) satellites, and serves to detect information of a position of the vehicle 11 including latitude and longitude of the vehicle 11 based on the received signals and to output the detected position information to the control unit 536. As a method of causing the position detecting unit 532 to detect the position information of the vehicle 11, a method in which a light detection and ranging or laser imaging detection and ranging (LiDAR) and a three-dimensional digital map are combined may be employed.

The speed detecting unit 533 is constituted, for example, by a vehicle speed sensor and serves to detect information on the speed of the vehicle 11 and to output the detected speed information to the control unit 536.

The position detecting unit 532 and the speed detecting unit 533 may detect information of the position and the speed by performing mobile communication based on a communication standard such as 3G; 4G; 5G; or Long Term Evolution (LTE). In this case, the information on the position and the speed may be detected, for example, by performing mobile communication with other vehicles, various sensors provided in the vicinity of a road on which the vehicle is traveling, and a server that acquires information of the other vehicles or the sensors.

The input unit 534 and the output unit 535 have the same functional configurations as the input unit 43 and the output unit 44, respectively.

The control unit 536 controls the operation of the control device 53. The control unit 536 is a processor which is constituted, for example, by hardware such as a CPU or an FPGA alone or in combination and performs various operation processes for causing the control device 53 to operate by reading various programs stored in the storage unit 537.

The storage unit 537 stores results of detection from the position detecting unit 532 and the speed detecting unit 533 and various types of information including various programs for performing the operation of the control device 53. The storage unit 537 is constituted by a RAM, a ROM, and the like.

The onboard device 5 may further include an onboard camera or a weight sensor as a means for ascertaining availability of a vehicular compartment. In this case, the onboard device 5 transmits data of an image captured by the onboard camera to the management device 2. The management device 2 ascertains availability of the vehicular compartment by image recognition based on the received data of an image. The onboard camera may capture an image only when a key to the vehicular compartment is unlocked.

A reader that can read information of a recording medium such as a two-dimensional code may be provided in the vehicular compartment, a recording medium which can be read by the reader is attached to a package of luggage, and the reader may read information on the recording medium and transmit a notification indicating that luggage is accommodated in the vehicular compartment to the management device 2 when luggage is accommodated at a predetermined position in the vehicular compartment.

Requester Terminal 6

The requester terminal 6 has the same functional configuration as the pickup and delivery person terminal 4. Specifically, the requester terminal 6 includes a communication unit 61, a short-range communication unit 62, an input unit 63, an output unit 64, a control unit 65, and a storage unit 66. The functional configurations of the communication unit 61, the short-range communication unit 62, the input unit 63, the output unit 64, the control unit 65, and the storage unit 66 are the same as the functional configurations of the communication unit 41, the short-range communication unit 42, the input unit 43, the output unit 44, the control unit 45, and the storage unit 46, respectively. In the requester terminal 6, the input unit 63 receives an input of delivery request information by a requester's operation and the communication unit 61 transmits the delivery request information to the management device 2.

User Terminal 7

The user terminal 7 has the same functional configuration as the pickup and delivery person terminal 4. Specifically, the user terminal 7 includes a communication unit 71, a short-range communication unit 72, an input unit 73, an output unit 74, a control unit 75, and a storage unit 76. The functional configurations of the communication unit 71, the short-range communication unit 72, the input unit 73, the output unit 74, the control unit 75, and the storage unit 76 are the same as the functional configurations of the communication unit 41, the short-range communication unit 42, the input unit 43, the output unit 44, the control unit 45, and the storage unit 46, respectively. In the user terminal 7, the input unit 73 receives an input of use request information by a user's operation and the communication unit 71 transmits the use request information to the management device 2.

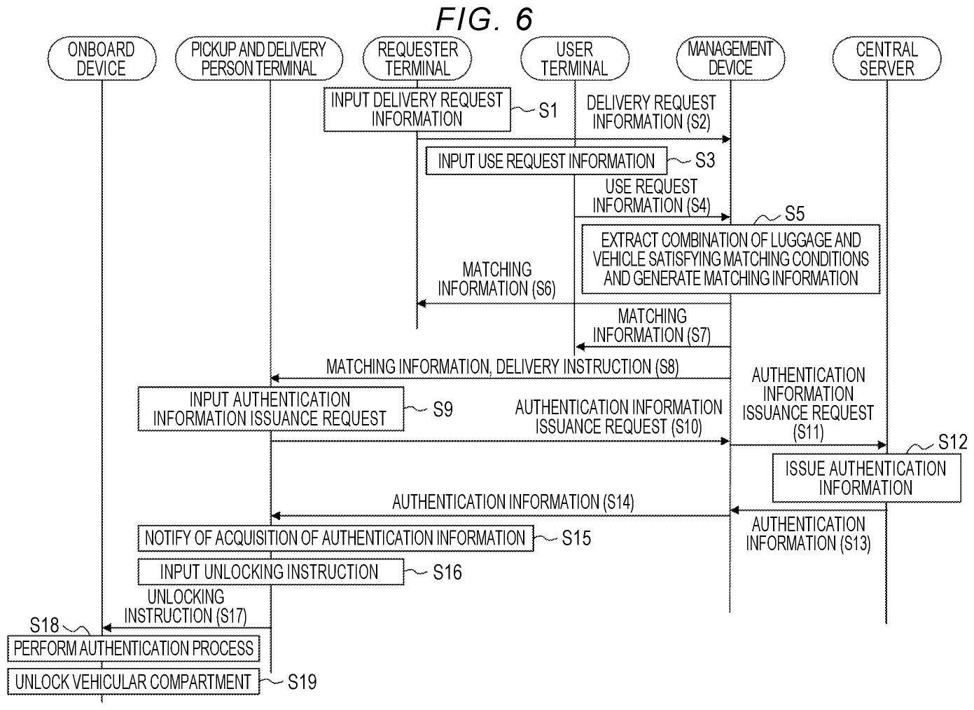

FIG. 6 is a sequence diagram schematically illustrating a process flow which is performed by the pickup and delivery system 1. In FIG. 6, a process flow until the management device 2 extracts a combination of luggage and a vehicle 11 satisfying matching conditions based on delivery request information from the requester terminal 6 and use request information from the user terminal 7 and the pickup and delivery person terminal 4 unlocks the vehicular compartment of the corresponding vehicle 11. Hereinafter, for the purpose of convenience of explanation, a process flow which is performed by the pickup and delivery system 1 including the requester terminal 6 and the user terminal 7 corresponding to the combination of luggage and a vehicle 11 extracted by the extraction unit 24 will be described.

First, when the requester terminal 6 receives an input of delivery request information by a requester's operation (Step S1), the communication unit 61 transmits the delivery request information to the management device 2 under the control of the control unit 65 (Step S2).

On the other hand, when the user terminal 7 receives an input of use request information by a user's operation (Step S3), the communication unit 71 transmits the use request information to the management device 2 under the control of the control unit 75 (Step S4). The order of the processes of Steps S1 and S2 and the processes of Steps S3 and S4 is arbitrary.

Subsequently, in the management device 2, the extraction unit 24 reads delivery request information of luggage and use request information of a vehicle 11 from the storage unit 23, extracts a combination of luggage and a vehicle 11 in which a delivery destination and a destination satisfy the matching conditions on the basis of the read information and generates matching information based on the result of extraction (Step S5). The matching information is, for example, information which has been described above with reference to the table 300 of FIG. 5. The time at which the extraction unit 24 performs the extraction process can be appropriately set and may be performed, for example, at intervals of a predetermined period.

Thereafter, the communication unit 21 transmits the matching information to the requester terminal 6 and the user terminal 7 corresponding to the extracted combination under the control of the control unit 22 (Steps S6 and S7). The communication unit 21 transmits the matching information and a delivery instruction to the pickup and delivery person terminal 4 corresponding to a pickup and delivery person who delivers the luggage to the vehicular compartment of the vehicle 11 (Step S8). The delivery instruction includes position of a current position of the vehicle 11.

When the pickup and delivery person who carries the pickup and delivery person terminal 4 having received the matching information and the delivery instruction arrives at the vehicle 11, the pickup and delivery person terminal 4 performs a process of unlocking the vehicular compartment of the vehicle 11 which is a delivery destination in response to the pickup and delivery person's operation. First, when the input unit 43 of the pickup and delivery person terminal 4 receives an input of an issuance request for authentication information based on the pickup and delivery person's operation (Step S9), the communication unit 41 transmits the issuance request for authentication information to the management device 2 under the control of the control unit 45 (Step S10). The issuance request for authentication information which is transmitted from the communication unit 41 includes information of the vehicle 11 which is a delivery destination and terminal information of the pickup and delivery person terminal 4.

In the management device 2 having received the issuance request for authentication information from the pickup and delivery person terminal 4, the communication unit 21 transmits the issuance request for authentication information to the central server 3 under the control of the control unit 22 (Step S11).

In the central server 3 having received the issuance request for authentication information, the authentication information issuing unit 34 issues authentication information based on the issuance request for authentication information (Step S12). At this time, the authentication information issuing unit 34 issues authentication information, for example, when it is determined that the vehicle 11 to be authenticated is a vehicle selected for pickup and delivery and the pickup and delivery person terminal 4 is a terminal having a valid right.

Thereafter, the communication unit 31 transmits the authentication information to the management device 2 under the control of the control unit 32 (Step S13).

The communication unit 21 of the management device 2 having received the authentication information from the central server 3 transmits the received authentication information to the pickup and delivery person terminal 4 under the control of the control unit 22 (Step S14).

In the pickup and delivery person terminal 4 having received the authentication information from the management device 2, the output unit 44 outputs an authentication information acquisition notification (Step S15). Thereafter, when the input unit 43 receives an input of an unlocking instruction through the pickup and delivery person's operation (Step S16), the short-range communication unit 42 transmits an unlocking request including the authentication information to the onboard device 5 of the vehicle 11 to be unlocked (Step S17). In order to perform the process of Step S17, the pickup and delivery person terminal 4 needs to be located within a communication range with the onboard device 5 of the vehicle 11 to be unlocked.

In the onboard device 5, the key unit 52 having received the unlocking request performs an authentication process (Step S18). Specifically, after the short-range communication unit 523 has received the unlocking request, the control unit 524 performs the authentication process by comparing the authentication information included in the unlocking request (terminal authentication information) with the authentication information stored in the storage unit 525 (device authentication information). When the authentication is successful, the control unit 524 causes the RF transmitter 522 to transmit an unlocking signal including a key ID.

When the RF receiver 512 of the locking/unlocking device 51 receives the unlocking signal, the locking/unlocking device 51 unlocks the vehicular compartment for loading luggage in the vehicle 11 (Step S19). Specifically, first, the control unit 513 compares the key IDs, and the control unit 513 controls the door lock actuator 514 such that the vehicular compartment for loading luggage in the vehicle 11 is unlocked when the comparison between the key IDs is successful. At this time, the locking/unlocking device 51 may perform answerback or the like to the key unit 52.

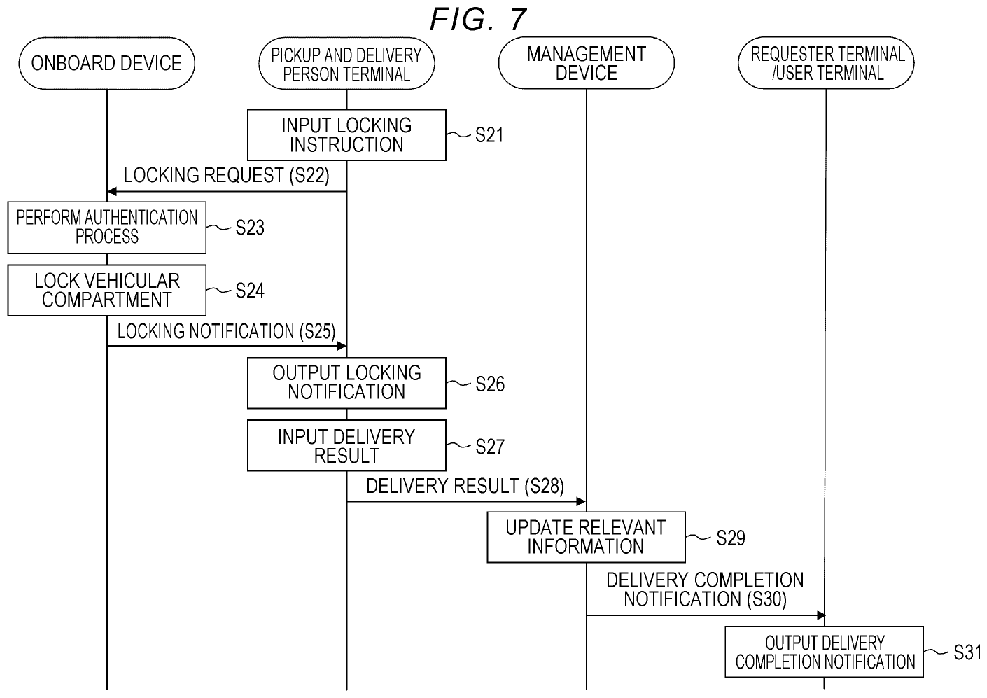

FIG. 7 is a sequence diagram schematically illustrating a process flow which is performed by the pickup and delivery system 1 and schematically illustrating a process flow of locking a vehicular compartment after a pickup and delivery person has loaded luggage into the vehicular compartment of the vehicle 11.

First, when the input unit 43 of the pickup and delivery person terminal 4 receives an input of a locking instruction through a pickup and delivery person's operation (Step S21), the short-range communication unit 42 transmits a locking request to the onboard device 5 of the vehicle 11 to be locked under the control of the control unit 45 (Step S22). In order to perform the process of Step S22, the pickup and delivery person terminal 4 needs to be located within a communication range with the onboard device 5 of the vehicle 11 to be locked.

In the onboard device 5, the key unit 52 having received the locking request performs an authentication process (Step S23). Specifically, after the short-range communication unit 523 has received the locking request, the control unit 524 performs the authentication process by comparing the authentication information included in the locking request (terminal authentication information) with the authentication information stored in the storage unit 525 (device authentication information). When the authentication is successful, the control unit 524 causes the RF transmitter 522 to transmit a locking signal including a key ID.

When the RF receiver 512 of the locking/unlocking device 51 receives the locking signal, the locking/unlocking device 51 locks the vehicular compartment for loading luggage in the vehicle 11 (Step S24). Specifically, first, the control unit 513 compares the key IDs, and the control unit 513 controls the door lock actuator 514 such that the vehicular compartment for loading luggage in the vehicle 11 is locked when the comparison between the key IDs is successful.

Subsequently, the onboard device 5 transmits a locking notification signal to the pickup and delivery person terminal 4 (Step S25). A specific process at this time is as follows. First, the LF transmitter 511 of the locking/unlocking device 51 transmits a locking notification signal to the key unit 52. In the key unit 52 having received the locking notification signal, the short-range communication unit 523 transmits a locking notification signal to the pickup and delivery person terminal 4 under the control of the control unit 524. At the time of transmission, the pickup and delivery person terminal 4 needs to be located within a communication range with the onboard device 5.

In the pickup and delivery person terminal 4 having received the locking notification signal, the output unit 44 outputs a locking notification (Step S26). Subsequently, when the input unit 43 receives an input of a delivery result from the pickup and delivery person (Step S27), the communication unit 41 transmits the delivery result to the management device 2 under the control of the control unit 45 (Step S28).

The control unit 22 of the management device 2 having received the pickup and delivery result updates various types of relevant information stored in the storage unit 23 (Step S29). The relevant information includes the delivery request information, the use request information, and the matching information.

Thereafter, the communication unit 21 of the management device 2 transmits a delivery completion notification to the requester terminal 6 and the user terminal 7 under the control of the control unit 22 (Step S30).

The output unit 64 of the requester terminal 6 and the output unit 74 of the user terminal 7 output information of the received delivery completion notification (Step S31).

Thereafter, the user drives the vehicle 11 to a destination. In a state in which luggage is accommodated in the vehicular compartment, the vehicular compartment may be set not to be unlocked and locked using the user terminal 7.

After the user has driven the vehicle 11 and has arrived at the destination, the requester receives luggage in a scheduled receipt time period which is registered in advance. When the management device 2 determines that the vehicle 11 has arrived at the destination based on information which is transmitted from the onboard device 5, the management device 2 may transmit arrival information of the vehicle 11 to the requester terminal 6. The user may transmit information indicating that the vehicle 11 has arrived at the destination to the management device 2 using the user terminal 7.

A process flow when a requester receives luggage will be described below. First, the requester unlocks the vehicular compartment of the vehicle 11 using the requester terminal 6. This unlocking process corresponds to a process flow in which the processes of the pickup and delivery person terminal 4 in Steps S9 to S19 are replaced with the processes of the requester terminal 6.

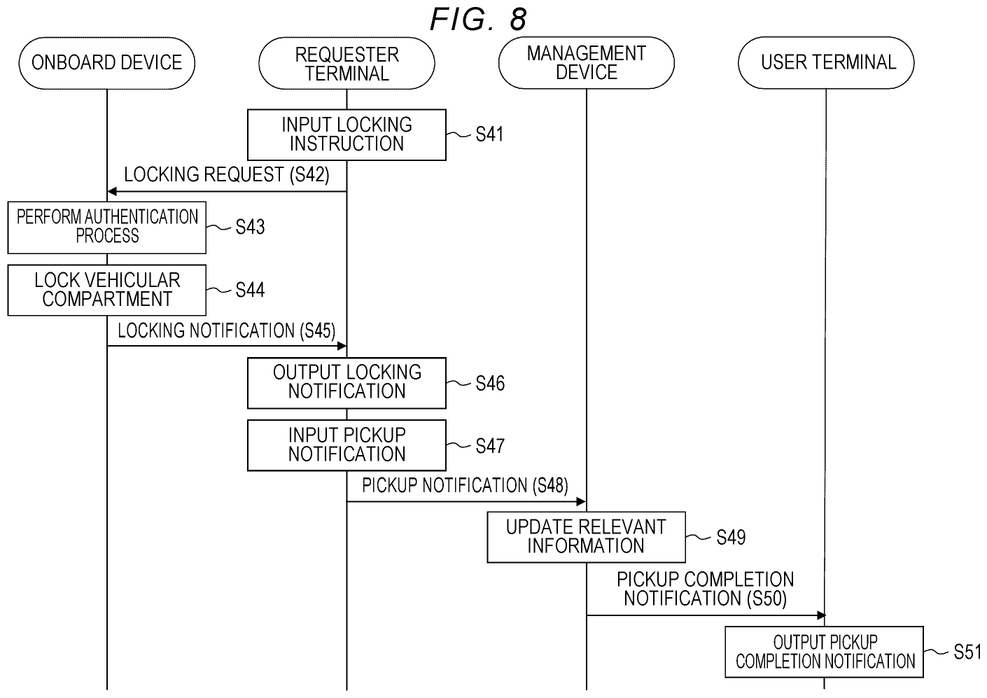

Thereafter, the requester having received luggage stored in the vehicular compartment performs a process of locking the vehicular compartment using the requester terminal 6. Hereinafter, the process of locking the vehicular compartment will be schematically described with reference to the flowchart illustrated in FIG. 8. Steps S41 to S46 correspond to a process flow in which the processes of the pickup and delivery person terminal 4 in Steps S21 to S26 are replaced with the processes of the requester terminal 6.

After Step S46, when the input unit 63 of the requester terminal 6 receives an input of a pickup notification through the requester's operation (Step S47), the communication unit 61 transmits the pickup notification to the management device 2 under the control of the control unit 65 (Step S48).

In the management device 2 having received the pickup notification, the control unit 22 updates various types of relevant information stored in the storage unit 23 (Step S49). The relevant information includes the delivery request information, the use request information, and the matching information.

Subsequently, the communication unit 21 transmits a pickup completion notification of luggage to the user terminal 7 under the control of the control unit 22 (Step S50).

In the user terminal 7 having received the pickup completion notification, the output unit 74 outputs the pickup completion notification (Step S51).

According to the above-mentioned embodiment, since a combination of luggage and a vehicle in which a delivery destination included in delivery request information and a destination included in use request information satisfy the matching conditions is extracted, it is possible to extract an appropriate combination of luggage and a vehicle and to achieve two individual purposes including rental of a vehicle and delivery of luggage using a single vehicle.

According to the embodiment, since the matching conditions include a condition that a distance between a delivery destination and a destination is equal to or less than a predetermined distance and a condition that a scheduled receipt of luggage is in a stopping/parking period at the destination of the vehicle, it is possible to extract a combination of luggage and a vehicle in which a distance between a delivery destination and a destination is small and a requester can reliably receive luggage.

According to the embodiment, since the matching information is transmitted to the requester terminal, the user terminal, and the pickup and delivery person terminal, all persons who are associated with delivery of luggage and use of a vehicle can share information and thus it is possible to achieve two individual purposes including rental of a vehicle and delivery of luggage.

Another condition may be added to the matching conditions which are referred to by the extraction unit 24. For example, the storage unit 23 may store the use history information of a vehicle 11 by a user, and the extraction unit 24 may extract a user with a use history desired by a requester. The use history which is mentioned herein includes a driving history when the vehicle 11 is used, a difference between request information and result information at the time of use, and delivery results of luggage. In this case, for example, a condition of a user whose a use history satisfies a predetermined reference may be added to the matching conditions. Examples of the predetermined reference include the number of times of delivery of luggage and a degree of accuracy in schedule of a user. Among these, the degree of accuracy in schedule is defined as an index which is calculated, for example, based on a difference between a schedule at the time of request for use and a use result and indicates that a less difference means a higher degree of accuracy.

When luggage is designated as a fragile object, at least one of a condition that an average traveling speed in a driving history of a user is equal to or less than a predetermined value and a condition that a maximum value of an acceleration magnitude is equal to or less than a predetermined value may be added to the matching conditions.

Periodic request for delivery of luggage and periodic request for use of a vehicle 11 may be enabled, and a condition that a delivery period of luggage and a use period of a vehicle 11 are the same may be added to the matching conditions.

A condition that at least one of an evaluation result by users at the time of request in the past by a requester and an evaluation result by requesters at the time of use in the past by a user satisfies a predetermined reference may be added to the matching conditions.

By adding another condition to the matching conditions in this way, it is possible to extract a more appropriate combination of luggage and a vehicle 11.

### Other Embodiments

While an embodiment of the disclosure has been described above, the disclosure is not limited to the embodiment. For example, a configuration in which pickup and delivery management of luggage and rental management of a vehicle are performed by different devices may be employed. In this case, any of the two devices may include the extraction unit.

After a vehicle in which luggage is loaded has arrived at a destination, a pickup and delivery person instead of a requester may pick up the luggage and deliver the luggage to the requester.

The management device may include the authentication information issuing unit and additionally have the function of the authentication management device.

Instead of the pickup and delivery system including a single management device and a central server, terminals that can perform some processes of the management device and the central server may be distributed to positions which are physically close to the pickup and delivery person terminal and a technique of edge computing that can efficiently transmit a large amount of data and shorten an operation processing time may be applied thereto.

New advantageous effects or modified examples can be easily derived by those skilled in the art. A broader aspect of the disclosure is not limited to the specific details described and illustrated above and the representative embodiments. Accordingly, the disclosure can be modified in various forms without departing from the idea or scope of the comprehensive concept of the disclosure which is defined by the appended claims and equivalents thereof.

What is claimed is:

1. A management device comprising:
a memory; and
a processor including hardware,
wherein the processor is configured to extract a combination of luggage and a vehicle in which a delivery destination included in delivery request information for requesting delivery of luggage and a destination included in use request information satisfy matching conditions based on the delivery request information and the use request information for requesting use of a vehicle which is able to be used through a request by a plurality of users and which is able to provide a vehicular compartment for loading luggage of which delivery is requested by a requester other than the users.

2. The management device according to claim 1, wherein the matching conditions include a condition that a distance between the delivery destination and the destination is equal to or less than a predetermined distance and a condition that the luggage is scheduled to be received in a parking/stopping period at the destination of the vehicle.

3. The management device according to claim 2, wherein the matching conditions further include a condition which is determined based on use history information of a user of the vehicle.

4. The management device according to claim 1, wherein the processor is configured to generate matching information including at least a part of the delivery request information and the use request information corresponding to the extracted combination, and
wherein the processor is configured to transmit the matching information to a requester terminal which is a transmission source of the delivery request information corresponding to the combination, a user terminal which is a transmission source of the use request information corresponding to the combination, and a pickup and delivery person terminal correspond to a pickup and delivery person of the luggage which is a part of the combination.

5. A management method which is performed by a management device including a memory and a processor including hardware, the management method comprising:
reading delivery request information for requesting delivery of luggage and use request information for requesting use of a vehicle which is able to be used through a request by a plurality of users and which is able to provide a vehicular compartment for loading luggage of which delivery is requested by a requester other than the users from the memory; and
extracting a combination of luggage and a vehicle in which a delivery destination included in the delivery request information and a destination included in the use request information satisfy matching conditions.

6. A management program causing a management device including a memory and a processor including hardware to perform:
extracting a combination of luggage and a vehicle in which a delivery destination included in delivery request information for requesting delivery of luggage and a destination included in use request information satisfy matching conditions based on the delivery request information and the use request information for requesting use of a vehicle which is able to be used through a request by a plurality of users and which is able to provide a vehicular compartment for loading luggage of which delivery is requested by a requester other than the users.
